(19) United States
(12) Patent Application Publication
(10) Pub. No.: US 2003/0051358 A1
(43) Pub. Date: Mar. 20, 2003

(54) Degree finding instrument

(76) Inventor: Ernest W. Kruse, Chino Hills, CA (US)

Correspondence Address: Ben. N. Lofstedt, Esq., P.O. Box 4189, Fullerton, CA, 92834, US

(21) Appl. No.: 09/952,874

(22) Filed: Sep. 14, 2001

(51) Int. Cl. B43L 7/10

(52) U.S. Cl. 33/471

(57) ABSTRACT

A improved combination degree finding and linear measuring instrument for directly indicating the degree, or angle, to be used for cutting and thereafterwards joining of the cut material items is disclosed, consisting of a pair of blade-shaped arms pivotally secured to each other at one end thereof to matingly conform to the inside or the outside engaged angle corresponding to the angle of the two pieces of the material which are to be joined. The true angle for accurately and precisely mating the material items to be cut is directly determined based upon a precise measurement of the pair of blade-shaped arms directly read as true angle measured which is indicated through an first offset sight aperture disposed over a first 180 degree scale and one-half of the angle indicated through the first offset sight aperture is indicated through a second offset sight aperture on the second 180 degree scale located on the opposite side of the instrument from the first offset sight aperture and the first 180 degree scale. Each of the arms includes measuring scales thereon for use as a ruler. The pair of blade-shaped arms are pivotally secured at one end of the pair of blades and can be pivotally adjusted to arrange the pair of arms to form a single long measuring arm at 180 degrees and locked into position by the threaded set screw and nut used to pivotally secure the pair of blades together. In fact, the pair of blades can be pivotally adjusted to form any angle between the blades.

### BACKGROUND OF THE INVENTION

1. Field of the Invention

The present invention relates to an degree finding device, and, more particularly, to measuring devices used to indicate angles between lines, surfaces and the like, such as the number of degrees engaged by the degree finding instrument and the angle indicated by the instrument can be read directly or determined by calculation via a differential measurement accomplished by this degree finding instrument.

2. Description of the Prior Art

Since the most ancient days of mankind, man has utilized instruments and tools to perform tasks that would be otherwise nearly impossible or very difficult to perform. Even if the task or work could be performed without using tools, at the very least, the results would be inferior to those produced with tools. Tools are typically designed to make a difficult job easier to perform. Oftentimes, the work to be performed can be accomplished more quickly and a much better result achieved by the utilization of the proper tool. In fact, tools have evolved so as to provide improved ways to perform tasks that would be fundamentally impossible without tools. The use of tools not only provides better ways of performing various tasks; such tools can help achieve improved results. By the use of tools, a worker may be able to provide results in situations where such could not be achieved at all absent the use of tools.

One significant and important function which a tool can perform is that of combining several operations in a fashion that simplifies the achievement of a final result. It is not unusual for a useful tool to combine two functions into one tool, such as holding and shaping an object, or holding and measuring an object. In either case, the tool is performing a function that might otherwise require more than a single tool or by a combination of a tool and manual labor. Ultimately, the end result of shaping, measuring, or whatever, is easily and accurately obtained via the use of a multiple function tool.

In fact, some tools perform functions that simply cannot be achieved without the use of that particular tool, or, may require the use of a similar tool. One example of such a tool is a measuring device. Typically, such tools are used to measuring linear distance s or angles. Of course, there are numerous other tools which measure other various parameters such as speed, velocity, pressure, acceleration, and the like. In dealing with the relatively uncomplex matter of measuring the distance between two points, it is impossible to precisely measure such distance without a scale. A common 12 inch long ruler, or measuring tape, art simple examples of the use and implementation of scales. To keep track of the quantity of scales, coupled with the scale on such a measuring device are numbers. The scale on a common 12 inch long ruler begins at “0” and ends with “12”.

It is simply not possible to accurately measure a distance without such a scale, because there is no reference or starting point. Whether the comparison be made visually, or otherwise, it is indeed possible to estimate the size of an object without the use of a scale, but such an estimate is made by comparison of the object with generally similarly sized object of roughly determining the measurement. However, this is inherently inaccurate.

In order to measure an object accurately, direct comparison to a scale must be used. As previously mentioned, one example of such a scale is a simple ruler with a scale impressed thereon that measures linear distances in inches or centimeters, or the like.

Another common type of measurement is the measurement of angles. Angular scales of measurement are reasonably analogous to linear scales of measurement in that a set base measurement is utilized, with such a set base measurement being replicated in a contiguous manner to form an ever-progressive scale. In the measurement of angles, the units of measurement are usually with reference to degrees. The measurement of degrees is frequently, and, conveniently, referenced to a circle, with a circle being divided into an equal number of divisions. Any two two dimensional lines, surfaces, or the like, that intersect form an angle. Such an angle can be measured in terms of the divisions of a circle. The most commonly used scale for measuring angles, as previously stated, uses a “degree” scale, with the circle be divided into 360 equal divisions, each division being named a “degree”. As an example, an angle that is measured between two intersecting lines, or the like, wherein the angular displacement between the two lines or surfaces is found to be one quarter (¼) of a circle, such would have an angular measurement of 90. Under many circumstances, the direct measurement of such an angle is adequate and can be measured by an angular scale that indicates this measurement directly. Such an angular scale is commonly known as a protractor.

There are numerous kinds of protractors which are commonly used to measure angles in units called “degrees.” The simplest kind of protractor is one that is formed in the share of a circle. Another basic type of protractor is formed in the shape of a semi-circle. Neither of these protractors has any moving parts. An angular scale is part of the protractor, and the protractor is simply placed against a pair of intersecting lines and the angle between such lines can be read directly from the angular scale on the protractor.

However, it should be noted that there are situations in which it is more useful to have an indicated measurement that is different than an actual measurement. The simplest example of this is the measurement of a drawing that is represented in a reduced scale. Using a ruler having a similarly reduced scale to measure the drawing gives a direct indication of the actual size of an object represented in the drawing, even though this is not the actual distance on the drawing. By the use of this method, an object of any size can be presented in a more appropriate size, due to the reduced scale. Such procedure of using a reduced scale is often used in engineering drawings, architectural drawings, and in similar representations of such character.

Another example of a scale indicating a converted type of measurement is a simple speedometer on a car, wherein the displacement of a pointer along a scale, whether the scale be angular or linear, indicates the speed at which the car is travelling.

This type of adapted scale offers pertinent information in a fashion that is very convenient to the user. The reason is simple. Little or no mathematical conversion is required in order to use the information gained from the scale.

The conversion of angular scales is substantially less common as compared to linear scaling systems. One of the reasons why this is so is that angular representation does not change in value when the magnitude of the scale is increased or decreased. Consequently, the identical scale can be utilized to measure virtually any angle.

It is possible that an altered angle scale might be required if the indicated angle is different than the actual measured angle. In such a case some mathematical computation would be required on the actual measured angle to obtain a meaningful result. One example of such a situation is found in the formation of a double beveled corner. To form a beveled corner, two pieces of material (typically wood) are each cut at an angle that is equal to one half of the actual angle between the two cut pieces to be joined. To form a finished angle of 90 degrees, such as typically found on each of the four (4) corners of a picture frame, each piece of material is cut at a 45 degree angle. Of course, it is possible to measure the 90 degree angle directly, and thereafterwards to simply divide the 90 degree angle by 2 to obtain the resulting cut angle of 45 degrees. However, it would be much more convenient for the artistian to utilize a measuring device which directly indicates the cutting angle of 45 degrees.

A single beveled angle offers an additional type of angle in which two pieces of material are joined together in a similar but slightly different manner than in a double beveled angle. In the single beveled angle situation, a single piece of material is cut at one end at a desired angle. This cut angle is the same angle that the other piece is readily mateable with. This piece of material to be adjoined thereto contacts this beveled surface along its side. To calculate the angle that a piece of material would be cut at for a single beveled angle, the angle between the two surfaces to be joined is measured. If the measured angle between the two surfaces is greater than 90 degrees, an angle which is 90 degrees less than the complementary angle is used. If the measured angle between the two surfaces is less than 90 degrees, the complementary angle of the measured angle is used.

U.S. Pat. No. 1,550,755 (Foner) relates to a measuring instrument for measuring angles of various multi-angled surfaces. The measuring instrument is a D-shaped frame 1 forming a protractor including a curved portion 2 and a straight portion 3. The straight portion 3 is provided with an ear or lobe 4 projecting from its outer edge intermediate its ends as illustrated in FIGS. 1 and 2. A pointer arm 6 is pivotally secured to the central portion of the bar 3 with one of the free ends of the pointer arm 6 overlapping the curved portion 2. The other portion of the pointer arm 6 extending beyond the pivoting point established by the screw 18 is identified as a relatively long blade 8. The arms 6 and 8 obviously swing about a common axis or pivoting point established by the centering screw 18. A relatively short arm or blade 11 is extends from the end of the straight portion 3 of the frame 1 of the protractor. A pair of liquid level gauges 31 and 33 are respectively mounted in the straight portion 3 of the frame 1 of the protractor and the relatively long blade 8. The free or outer ends of the arms or blades 8 and 11 are fitted with detachable wear tips 19 and 20 which must be replaced when they become worn after continued use. Portion 2 is provided with a scale 21 along its outer edge, and a scale 22 along its inner edge, and a protractor scale 23 disposed intermediate of scales 21 and 22. The free end portion of the arm 6 is equipped with an opening 24 through which the scales 21, 22 and 23 are exposed, and is further provided with pointers 25 and 26 projecting from the outer and inner ends of the opening 24. This measuring device is limited for use in the measurement of inclined exterior, or outside, angles. It does not teach the use of this instrument in the measurement of inside angles. Additionally, measurement errors will develop as the detachable wear tips 19 and 20 wear, and/or in addition as their respective mounting screws become loose. Measurement errors will also develop if the curved portion 2 is distorted by bending with respect to the straight portion 3.

U.S. Pat. No. 1,145,719 (Tucker) relates to a combination rule and drafting instrument. This instrument can be used as a protractor, square, bevel square, straight edge, compass, scale for obtaining roof pitch, rafter cuts, polygon miter cuts, elbow miter lines and scratch gage. The arms A and B are pivotally connected with each other by a pivot C to allow swinging of the arms into an angular position of one arm relative to the other to form an ordinary square or a bevel square, and to allow the extending of the arms to form a straight edge. A handle D is used to clamp the two pivoting arms A and B in relatively fixed position. A radial line F is cut on the adjacent face of the arm A so that when the arms A and B are moved into an angular position, the degree of the angle formed by arms A and B

U.S. Pat. No. 1,550,755 to Steinle discloses an angulometer that is used to measure the relative angle between two lines or surfaces, including a magnifying lens to allow a very fine angular scale to be read easily.

U.S. Pat. No. 1,585,563 (Schlattau) describes a combination measuring instrument that measures the relative angle between two lines or surfaces, and provides a linear measuring scale, a means for measuring the outside diameter of an object, and also a scale that is used to measure the diameter of a bolt or a piece of wire. The scale for measuring a bolt or a piece of wire is an enlarged scale.

U.S. Pat. No. 1,655,887 (Bailey) teaches a protractor that may be used to very accurately measure angles between two lines or surfaces or to very accurately measure very small angles, and works in the following manner. As the blades 5 and 6 are moved angularly with respect to one another, gear teeth 9, which are part of ring 7 that is in turn attached to blade 5, cause the free turning gear 11 to rotate. Gear 11 is part of the plate 10 that is attached to blade 6. Gear 11 meshes with gear 12 and causes it to turn. Rigidly attached to gear 12 is plate 13. Plate 13 is caused to be angularly displaced at a much greater rate then the two blades 5 and 6 are separated at. This is because the ratio of the gear teeth on gears 9, 11 and 12 cause gear 12 to move at an angular speed that is greater than gear 9.

U.S. Pat. No. 2,735,185 (Naphtal) relates to a protractor that is used to measure angles between two lines or surfaces. The angle of the protractor is lockable thereby also allowing it to be usable to recreate the angle in order to draw it accurately on paper or wherever. The angle is viewed through a magnifying bubble located above the scale.

U.S. Pat. No. 4,144,650 (Rawlings et al) discloses a multifunction level that again shows the relative angle between two lines or surfaces. This level can be locked at a particular angle, if desired, with the locking mechanism accessible from either side of the level, thus making it easier to use.

U.S. Pat. No. 4,394,801 (Thibodeaux) describes a construction tool that is used to measure the relative angle between two lines or surfaces or between horizontal or vertical and such a line or surface. It also indicates roof pitch on a separate scale. Bubble type levels are included to orient the construction tool with respect to horizontal or vertical.

U.S. Pat. No. 4,562,649 (Ciavarella) teaches an adjustable carpenter's square for use determining the relative angle between two lines or surfaces. The absolute angle between the two lines is indicated, and is viewed through opening 31.

U.S. Pat. No. 4,733,477 (Fincham et al) discloses a chalk line framing square that provides a device that is designed to aid in placing right angle intersecting chalk lines upon a floor so that tiles can be properly installed on the floor. It includes two arms that pivot with respect to one another and an angular scale that indicates the angle between the two arms.

U.S. Pat. No. 4,745,689 (Hiltz) discloses a measuring and layout tool that has a plurality of levels therein and indicates the relative angle between two lines or surfaces.

The present invention has arisen to mitigate and/or obviate the aforementioned disadvantages of the conventional drawing instruments. These together with other objects of the invention, along with the various features of novelty which characterize the invention herein, are described with particularity in the claims appended hereto and forming a part of this application. For a more complete and further and better understanding of the invention, its operating advantages and the specific objects obtained by its applications and uses, reference should be had to the accompanying drawings and description mater in which there is illustrated preferred embodiments of the invention.

While there has been rather broadly outlined the features and objects of the more important features of the present invention so that the detailed description thereof which follows may be more easily understood, and that the present inventive contribution to the art may be better appreciated. There are, obviously, further features of the instant invention that will be described hereinafterwards and which will form the subject matter of the claims appended hereto.

In this particular respect, prior to explaining at least one embodiment of the invention in great detail, it is to be understood that the invention is not limited in its application to the details of construction and to the arrangements of the components set forth in the following description or illustrated in the drawings. The invention is capable of numerous other and alternative embodiments, and of being practiced and formed in various other ways without departing from the scope of the invention described herein. It is important that it should be understood that the phraseology and terminology employed herein are for the purpose of description and should not be regarded as limiting the invention.

Further, those skilled in the art will appreciate that the inventive conception upon which the present disclosure is based may be readily utilized as a basis for the designing of other structures, and systems for carrying out the several purposes of the instant invention described herein. It is important, therefore, to appreciate and understand that the claims be regarded as including all such equivalent constructions and adaptations that do not depart from the scope and spirit of the invention described herein.

Additionally, the purpose of the foregoing abstract is to enable the United States Patent and Trademark Office and the public generally, and especially, the scientists, engineers and practitioners in the art who are not familiar with patent or legal terms or phraseology, to ascertain promptly, from perusal, the nature and essence of the technical disclosure of the application. The ABSTRACT, therefore, is neither intended to define the invention of the application, which is properly measured by the claims, nor is it intended to be limiting as to the scope or spirit of the invention in any way.

Objects and advantages of the within-described and disclosed invention will become apparent from the following description taken in conjunction with the accompanying drawings wherein are set forth, by way of illustration and example, certain preferred embodiments of the present invention.

The drawings constitute a part of this specification and include exemplary embodiments of the instant invention and illustrate various objects and features thereof.

### SUMMARY OF THE INVENTION AND OBJECTS

Basically, the invention disclosed herein is a degree finding instrument for indicating the degree, or angle, to be used for cutting and thereafterwards joining of the cut material items is disclosed. Two arms with are pivotally secured to each other at one end thereof so as to matingly conform to the engaged angle which corresponds to the angle of the two pieces of the material to be joined. The indicated angle is directly determined based on the engaged angle. More specifically, the present invention consists of an improved combination degree finding and linear measuring instrument for directly indicating the degree, or angle, to be used for cutting and thereafterwards joining of the cut material items is disclosed, consisting of a pair of blade-shaped arms pivotally secured to each other at one end thereof to matingly conform to the inside or the outside engaged angle corresponding to the angle of the two pieces of the material which are to be joined. The true angle for accurately and precisely mating the material items to be cut is directly determined based upon a precise measurement of the pair of blade-shaped arms directly read as true angle measured which is indicated through an first offset sight aperture disposed over a first 180 degree scale and one-half of the angle indicated through the first offset sight aperture is indicated through a second offset sight aperture on the second 180 degree scale located on the opposite side of the instrument from the first offset sight aperture and the first 180 degree scale. Each of the arms includes measuring scales thereon for use as a ruler. The pair of blade-shaped arms are pivotally secured at one end of the pair of blades and can be pivotally adjusted to arrange the pair of arms to form a single long measuring arm at 180 degrees and locked into position by the threaded set screw and nut used to pivotally secure the pair of blades together. In fact, the pair of blades can be pivotally adjusted to form any angle between the blades.

One of the primary and most significant features of the instant invention described in detail herein is that it alleviates uncertainties when attempting to determine angles and miters for the precise installation of trim and molding to walls and ceilings.

As can be realized by one familiar and skilled in the art to which the present invention applies, the above specification of the invention provides a new and useful device for measuring angles and directly reading miter saw setup values directly.

With the foregoing general objects outlined, and with other specific objects in view, which will be more completely understood as the nature of the invention is more specifically detailed herein, the present invention resides in the combination and arrangement of parts and in the details of construction hereinafter described and claimed, it being understood that changes in the precise embodiment of the invention herein disclosed can be made within the scope of what is claimed without departing from the spirit of the invention.

### BRIEF DESCRIPTION OF THE DRAWING FIGURES

With continuing reference to all of the drawings herein, it should be noted that like figures represent like elements in each of the figures. The operation, variations of the design and features of the present invention will be more fully realized and appreciated through a perusal of the drawing figures in conjunction with the reading of the following description wherein:

FIG. 1 is an assembly view of the top portions of the present invention in perspective.

FIG. 2 is a bottom view of the instant invention showing the two arms in a relatively closed position.

FIG. 3 is a view of the top portions of the present invention illustrating the measurement of a 13 degree angle.

FIG. 4 is a view of the bottom view of the present invention showing the two arms in a relatively closed position.

FIG. 5 is a view of the present invention shown measuring an outside angle of 90 degrees.

FIG. 6 is a view of the present invention with the linear measuring blades shown extended to form a long straight edge or ruler which is approximately twice the length of each individual blade.

FIG. 7 is an enlarged view of the top portion of the instrument showing the measurement of an inside 90 degree corner.

FIG. 8 is an enlarged view of the bottom portion of the instrument showing the measurement reading of one-half of the 90 measurement of shown and illustrated in FIG. 7.

### DESCRIPTION OF PREFERRED EMBODIMENT OF THE INVENTION

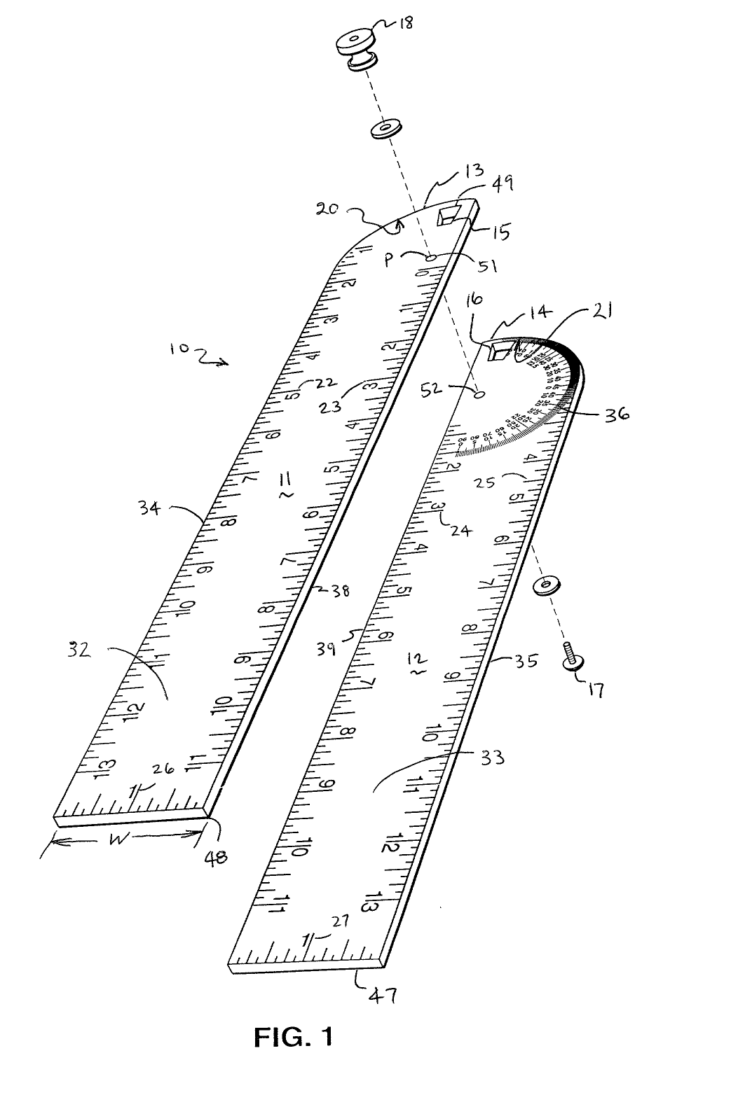

With regards to all of the drawings herein, and with specific emphasis now to FIG. 1, there is shown the present invention an improved combination degree finding and linear measuring instrument 10 for directly indicating the degree, or angle, to be used for cutting and thereafterwards joining of the cut material items is disclosed, consisting of a pair of blade-shaped arms 11, 12 pivotally secured to each other at the ends 13, 14 by means of a pair of complementary apertures 15, 16 with a bolt 17 and nut 18 combination.

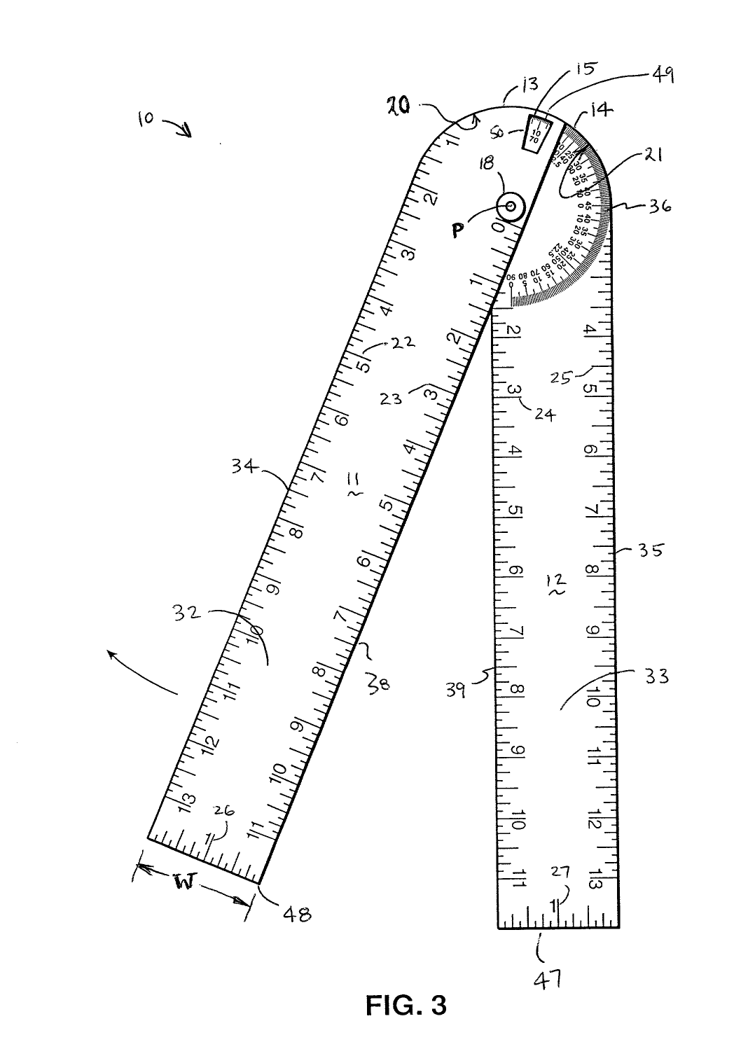

As specifically illustrated in FIG. 3, the first arm 11 and the second arm 12 are joined together in variable angular relationship. The first arm 11 and the second arm 12 are preferably joined together in pivotal relationship to each other typically by means of a bolt 17 and nut 18 combination. Of course, the bolt 17 and nut 18 combination could readily be substituted with a pin or rivet combination which is equivalent to the function of the bolt 17 and nut 18 combination shown in the drawings herein.

With special emphasis now also on FIGS. 1 and 3, one end 13 of the first arm 11 has a radiused portion 20 across it's full width, W. A complementary radiused portion 21 is formed on the second arm 12. At the center of each of radiused portions 20, 21 are a pair of complementary apertures 15, 16 through which a bolt 17 and nut 18 combination are joined to form a pivot at P to pivotally secured the pair of blade-shaped arms 11, 12 to each other to allow the first arm 11 and the second arm 12 to be pivotally moved in variable angular relationship to each other as depicted in FIG. 3. The function and purpose of this variable angular relationship will be understood more clearly as the detailed description of the preferred embodiment proceeds further herein.

As shown and illustrated in all of the Figures herein, situated along each edge of the blade-shaped arms 11, 12 are linear measuring scales 22, 23, 24, 25, 26 and 27. Such ruler-type scales may be arranged to function in inches or in centimeters, or any other desired measurement system. Such scales are useful in many ways as well known in the prior art. In the preferred embodiment disclosed herein the arms 11, 12 are 13 and ⅝inches long and have a width, W, of 2 inches. On the top sides 32, 33 of the blades 11, 12 forming the within instrument 10, along the outer-facing portions 28, 29 of the arms 11, 12 are measurement scales starting from the ends of the arms 11, 12 having the complementary sight apertures 15, 16 therethrough with indicia thereon commencing at 1 inch and increasing in size up to 13 inches. Along the inner-facing portions 30, 31 of the top sides 32, 33 of the arms 11, 12 are measurement scales starting from the same ends of the arms 11, 12 with the complementary sight apertures 15, 16 therethrough with indicia thereon commencing with 0 inch and increasing in size up to 11 inches. The 0 inch indicia on each of the arms 11, 12 is aligned with the straight edge of the other complementary arm to allow convenient measurement therefrom. A complementary pair of apertures 51, 52 in the blade-shaped arms 11, 12 are drilled through blades in complementary fashion at a location in the blade-shaped arms 11, 12 which is about 18.75 percent of the width, W, of the blade-shaped arms as measured from the inside edges 38, 39 of the blades 11, 12 and 84.375% of the width, W, of the blade-shaped arms as measured from the outermost end 13, 14 of the arms 11, 12. The length of the arms 11, 12 is preferably about thirteen and five-eighths inches long. The outside radii of each of the ends 13, 14 are preferably one and eleven-sixteenths inches. Incorporation of the radii 20, 21 at each of the ends 13, 14, the interference between the rectangular ends of the arms 11, 12 in the process of measuring angles between inside corners is eliminated.

A bolt 17 is passed through the complementary apertures 51, 52 and the threaded end of the bolt 17 is threadably secured to a finger nut 18 whereby the combination of the finger nut 18 and the bolt 17 provide a pivoting means for the two arms 11, 12. The finger nut 18 and the bolt 17 also are used as a means for locking the arms 11, 12 with respect to each other as desired by the user of the within instrument 10.

### How the Idea Came About

The idea came to the inventor when he was working with “crown molding.” “Crown molding” consist primarily of wooden strips that are put on the wall along the ceiling line for decoration purposes. The seams of the crown molding would not seam right in the inside (as opposed to the outside ) corners because the corners of the vertical walls were not a true 90 degrees with respect to one another. So, the inventor herein set out looking for a tool to measure the degree of the inside corner. Outside corners were not a problem, but, there was no tool for measuring the true angle of the inside corner.

Basically, the inventor had to think of a way for a tool to fit inside an inside corner to give the degrees of the inside angle between the two vertical walls. The inventor knew that it had to work like a protractor to give the degree, but the inside corner itself was the problem.

After working with many different designs, the present invention 10 was created.

### How It Works

This instrument 10 was primarily designed to be used to make accurate cuts with a miter saw because an inside corner is rarely ninety (90) degrees between the two (2) vertical surfaces.

By design, this instrument 10 will work, however, for measuring the number of degrees between BOTH the INSIDE and the OUTSIDE corners formed by two intersecting walls.

### Method for Measuring an Inside Corner

To measure the number of degrees on an inside corner, the instrument 10 is opened to a 90 degree position as shown and illustrated in FIGS. 7 and 8. The radii 20, 21 of the ends 13, 14 of the two (2) pivotally-joined ends 13, 14 of the arms 11, 12 of the instrument 10 are positioned into the inside corner and the arms 11, 12 are pushed outwardly so that the outside edges 34, 35 of both arms 11, 12 touch the two walls forming the inside corner. Once this is done, the finger nut 18 is manually tightened to lock the two arms 11, 12 in fixed position with respect to each other. Once this is done, as illustrated in FIG. 8, the entire instrument 10 is flipped and the number of degrees are then read from the first 180 degree protractor scale 36 on the first of the pivotally-joined ends 14 of the second arm 12 of the instrument 10 through the first sight aperture 15 in the first arm 11 which is disposed over the first 180 degree protractor scale 36 on the second arm 12. In this preferred embodiment, the number of degrees is read through the first sight aperture 15 from the first 180 degree protractor scale 36 on the first arm 12 as the true angle between the two generally vertical walls between which the inside corner is formed. Such a measurement is illustrated in FIG. 3 with the angle indicated as 13 degrees through the first sight aperture 15 through the first arm 11 which is disposed over the first 180 degree protractor scale 36 of the instrument 10. The instrument 10 is then turned over to expose the bottom sides and the number of the degrees necessary to cut the bevel on each of the crown molding material is read from the second 180 degree protractor scale 37 on the first arm 11 of the instrument 10 through the second sight aperture 16 in the first arm 12 of the instrument 10. This reading, in degrees, is exactly one-half (½) of the true measured angle of the inside corner, which in FIG. 3 the true measured angle is 13 degrees. The reading of one-half of 13 degrees would be 6.5 degrees.

To cut a pair of crown molding strips to match to the inside corner using this instrument 10, the cutting angle of the two crown molding pieces to be matched is determined by adding the one-half (½) of the true measured angle reading to the angle number directly beneath the number of degrees read through the sight aperture 16 in the first arm 12 which is disposed over the first 180 degree protractor scale 37 on the first arm 11. The sum of these two numbers is 90 degrees.

### Method for Measuring an Outside Corner

To measure the number of degrees on an outside corner, the tool 10 is opened to a 180 degree position. The second arm 12 and first arm 11 are pushed inwardly so that the inside edges of both arms, 12 form an inside corner and touch the two vertical walls forming the outside corner being measured. The inside corner formed by the two inside edges 38, 39 of the second arm 12 and the first arm 11 at the two pivotally-joined ends 13, 14 of the arms 11, 12 of the instrument 10 is then aligned with the outside corner whose angle is being measured and the first and second arms 11, 12 are then moved into intimate engagement with the two walls forming the outside corner. Once this is done, the finger nut 18 is manually tightened to lock the two arms 11, 12 in fixed position with respect to each other. The number of degrees is then read from the first 180 degree protractor scale 36 on the first end 14 of the pivotally-joined ends 13, 14 of the second arm 12 of the instrument 10 through the first sight aperture 15 in the first arm 11 which is disposed over the first 180 degree protractor scale 36 on the first arm 12. In this preferred embodiment, the top number is read as the true angle between the two generally vertical walls which form the outside corner being measured. The instrument 10 is then turned over and the number of the degrees necessary to cut the bevel on each of the crown molding material is read from the second scale 37 on the first arm 11 of the instrument 10 through the second sight aperture 16 in the first arm 12. This reading is exactly one-half (½) of the true measured angle of the outside corner.

To cut a pair of crown molding strips to match to the outside corner using this instrument 10, the cutting angle is determined by the measured angle reading on the other side of the instrument 10 read through the sight aperture 16 in the second arm 12 which is disposed over the first 180 degree protractor scale 37 on the first arm 11. The read angle is one-half of the measured outside angle.

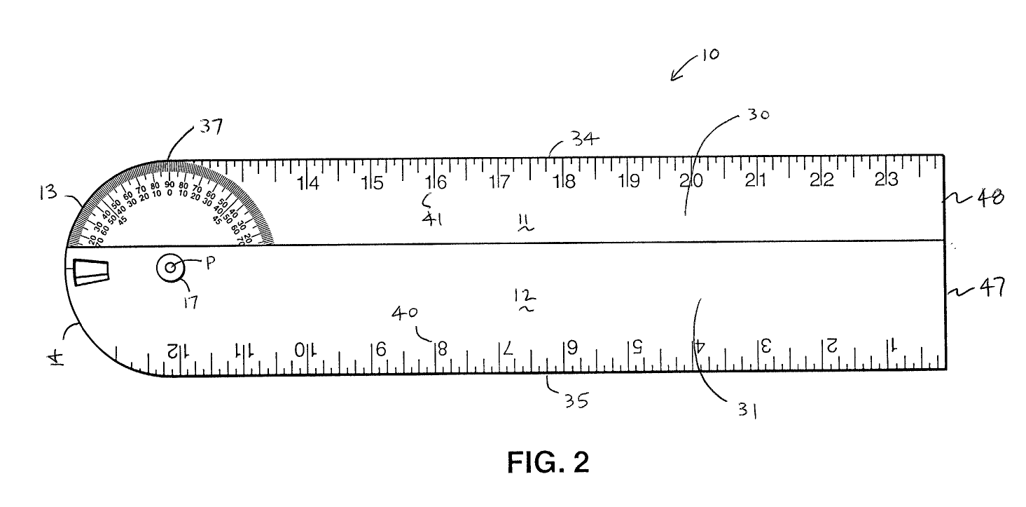

As shown and illustrated in FIG. 2, the first arm 12 and the second arm 11 of the instrument 10 can be pivotally folded back to form a pair of straight edges 34, 35 with measuring scales 40, 41 along both of the outside straight edges 34, 35.

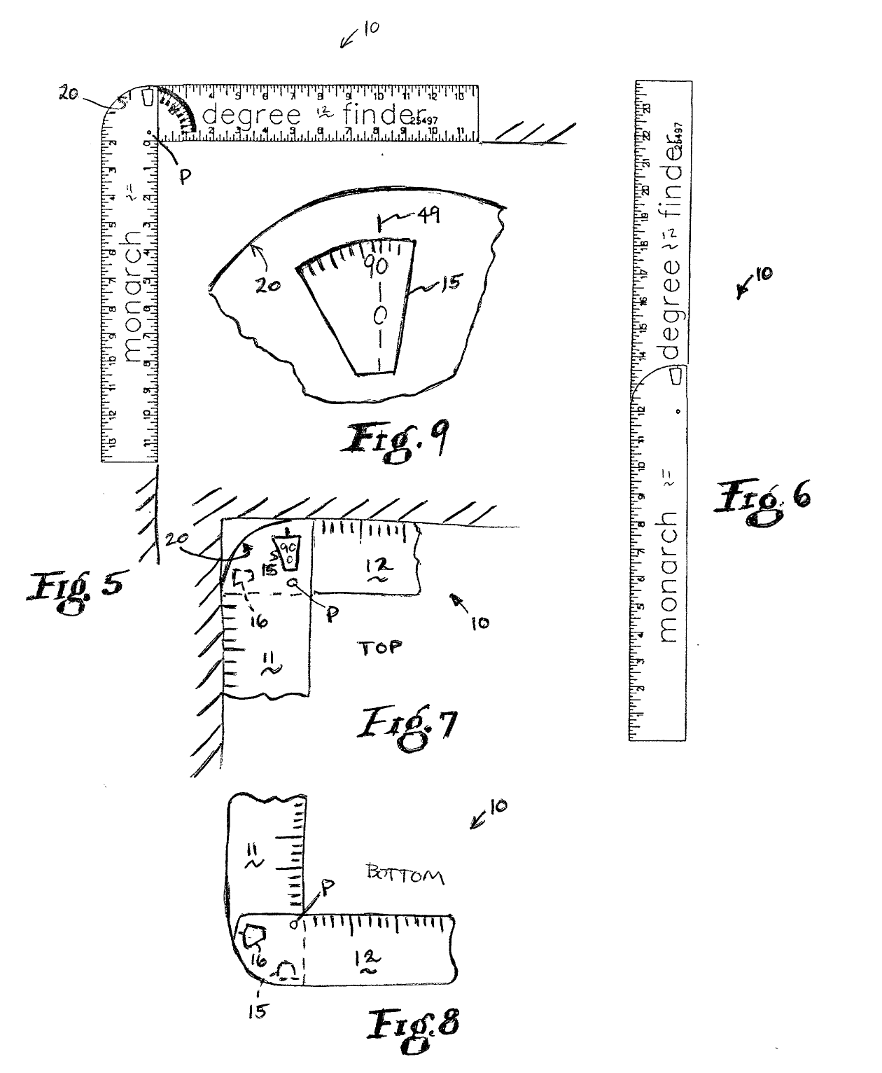

As illustrated in FIG. 4, a second view of the instrument 10 similar to the instrument 10 FIG. 2 showing five sets of measuring scales 42, 43, 44, 45 and 46 are noted along five of the straight edges of the instrument 10 including a pair of matching scales 45 and 46 along the non-pivoting ends 47, 48 of the second arm 12 and the first arm 11.

It should be carefully noted that the sight aperture 15 shown and illustrated are arranged slightly offset with respect to the alignment scribe 49 as shown in FIGS. 1 and 3 thereon. The sight apertures 15, 16 are sufficiently large to always allow the numbers on the particular protractor scale therebeneath, whether 36 or 37, to be read therethrough so that when the arms 11, 12 are locked, user of the instrument 10 can be assured that when he turns the measurement instrument 10 over and looks through the aperture, whether 36 or 37, that meaningful numbers can be seen along with the scales 36 or 37 to avoid the necessity of untightening the finger nut 18 and bolt 17 combination to allow the two arms 11, 12 to pivot so that, for example, the edge 50 of the aperture 15, can be moved to allow the interested party to see the scale 36 and the angle measuring indicia thereon.

The present instrument may be utilized in a large number of ways. One or two uses of the instrument has been described, and other uses and capabilities will become obvious to those skilled in the art and to the user. The uses of the instrument will readily suggest themselves to the user, after the user has once grasped the fundamental principles of this measuring device.

The present instrument may be employed in various professions and by various artisans or mechanics in their own particular line of work activity. It will be naturally evident without lengthy description as a protractor, a square, and a miter or bevel gauge.

While the invention described and detailed herein is susceptible to various modifications and alternative forms, specific embodiments thereof have been shown by way of example in the drawings. It should be understood, however, that it is not intended to limit the invention to the particular forms disclosed, but, on the contrary, the intention is to cover all modifications, equivalents, and alternatives falling within the spirit and scope of the invention as defined by the appended claims.

What I claim as my invention is:

1. An improved combination degree finding and linear measuring instrument for directly indicating the angle to be used for cutting and thereafterwards joining of the cut material items, comprising:
(a) a pair of blade-shaped arms with a pair of complementary apertures through each one of the pair of corresponding ends of the arms;
(b) means for pivotally securing the pair of arms through the pair of complementary apertures through the pair of arms;
(c) a pair of 180 degree protractor scales drawn on the ends of the arms pivotally secured to each other;
(d) a pair of sight apertures through which to read the indicia on the 180 degree protractor scales alignably disposed therebeneath; and
(e) an pair of alignment scribe lines operably associated with the sight apertures, whereby the scribe lines are disposed offset from the center line of the sight apertures to allow additional indicia to be read through the sight apertures on one side thereof than with respect to the other side of the center line of the sight apertures.

2. The improved combination degree finding and linear measuring instrument of claim 1 wherein the outside facing ends of the pivoting arms are radiused.

3. The improved combination degree finding and linear measuring instrument of claim 1 wherein the means for pivotally securing the pair of arms further includes locking means for the pair of arms.

3. The improved combination degree finding and linear measuring instrument of claim 1, wherein the pair of blade-shaped arms having a complementary set of apertures adjacent one end thereof include linear measurement scales along at least one longitudinal edge thereof.

4. The improved combination degree finding and linear measuring instrument of claim 1, wherein the means for pivotally securing the pair of arms through the apertures therethrough further comprises locking means operatively associated with the pair of apertures.

5. The improved combination degree finding and linear measuring instrument of claim 1, wherein the means for pivotally securing the pair of arms through the apertures therethrough is a finger nut and bolt combination.

6. The improved combination degree finding and linear measuring instrument of claim 1, wherein the pair of blade-shaped arms having a pair of complementary apertures through each one of the pair of corresponding ends of the arms and adjacent to the inside facing longitudinal edges thereof and located about the length of the width of the blade from the outermost edge of the corresponding ends of the arms and about 25 percent of the width of the blade-shaped arms from the inside longitudinal edge of the blade-shaped arms.

7. The improved combination degree finding and linear measuring instrument of claim 1 wherein the pair of blade-shaped arms having a complementary set of apertures adjacent one end thereof include linear measurement scales along at least one transverse edge thereof.

8. The improved combination degree finding and linear measuring instrument of claim 1 wherein the width of each blade is about two inches.

9. The improved combination degree finding and linear measuring instrument of claim 1 wherein the pair of complementary apertures in the pair of blade-shaped arms are each located three-eighths of an inch from the inside edge of the blade-shaped arms and one and eleven-sixteenths inches from the nearest longitudinal end of the arm.

10. The improved combination degree finding and linear measuring instrument of claim 1 wherein the pair of complementary apertures in the pair of blade-shaped arms are each located three-eighths of an inch from the inside edge of the blade-shaped arms and one and eleven-sixteenths inches from the nearest longitudinal end of the arm.

11. The improved combination degree finding and linear measuring instrument of claim 1 wherein the pair of complementary apertures in the pair of blade-shaped arms are each located eighteen and three-quarters percent of the width of the blade-shaped arms in from the inside edge of the arms and eighty-four and three-eighths percent of the width of the arms from the nearest longitudinal end of the arm.

12. The improved combination degree finding and linear measuring instrument of claim 11 wherein the outside facing portions of the ends of the arms which pivot are radiused about the pivot using a radius of about one and eleven-sixteenth inches.

13. The improved combination degree finding and linear measuring instrument of claim 1 where the pair of complementary apertures in the pair of blade-shaped arms are located adjacent to the inside facing longitudinal edges thereof and about the length of the width of the blade from the outermost edge of the corresponding ends of the arms.
